(19) United States
(12) Patent Application Publication
(10) Pub. No.: US 2014/0047998 A1
(43) Pub. Date: Feb. 20, 2014

(54) CURING OR SEALING COMPOSITIONS FOR CONCRETE AND CEMENT, AND METHODS FOR THE PREPARATIONS AND USE THEREOF

(71) Applicant: Momentive Specialty Chemicals Inc., Columbus, OH (US)

(72) Inventor: Steven J. Wantling, Hoover, AL (US)

(73) Assignee: Momentive Specialty Chemicals Inc., Columbus, OH (US)

(21) Appl. No.: 13/968,048

(22) Filed: Aug. 15, 2013

Related U.S. Application Data
(60) Provisional application No. 61/683,793, filed on Aug. 16, 2012.

(51) Int. Cl. C04B 24/02

(52) U.S. Cl. CPC C04B 24/023
USPC 106/660; 106/822

(57) ABSTRACT

Disclosed are wax emulsion compositions for curing or sealing concrete and cement formulations, methods for preparing and processes for using the same. The modifiers are applicable to curing or sealing membranes, used in roadways, highways, parking lots and other freshly placed or poured concrete surfaces to retain moisture and achieve high compressive strengths. This invention also relates to materials used to coat, spray, brush, roll, etc. on conventional Portland cement concrete mix designs or other applied concrete mixes in formed structural shapes and transport road mix designs, providing an effective layer that controls and minimizes moisture loss from the mix to enable proper curing and achievement of desired compressive strengths.

### RELATED APPLICATION DATA

This application claims benefit to U.S. Provisional Application No. 61/683,793, filed Aug. 16, 2012, of which the entire contents of the application are incorporated by reference herein.

### FIELD OF THE INVENTION

The present invention relates to compositions useful for curing or sealing “cast-in-place” concrete and cement formulations, such as roller compacted, pervious, or slip form concrete, and to methods for their preparation and use. The compositions of the invention include a paraffin hydrocarbon wax and an alkanol ethoxylate or an alkylphenol ethoxylate surfactant. The compositions of the invention are useful for curing or sealing concrete used in roadways, highways, parking lots and other freshly placed or poured surfaces, and provide an effective layer that controls and minimizes moisture loss from the mix, for proper curing and high compressive strengths.

### BACKGROUND OF THE INVENTION

Concrete requires some form of a curing membrane in order to provide a water impermeable layer to keep moisture in the concrete mix from evaporating too quickly, thereby maintaining a proper hydration level for correct curing and compressive strength development.

Currently available liquid materials for curing or sealing purposes include acrylic based resins, emulsion polymers, wax emulsions, urethane based polymers, naturally derived materials and others. Some are used for individual purposes, either sealing or curing, and others serve dual purposes as both sealing and curing compounds. These materials are typically formulated with pigments such as titanium dioxide (TiO₂) to serve as a reflecting surface to sunlight, to minimize heat absorption thereby lowering the temperature of the curing concrete, to allow for proper curing, strength development and reducing internal stresses.

Water based materials for both sealing and curing applications are highly desirable because of ease of handling and clean-up, the elimination of volatile organic compounds, and the elimination of flammability hazards associated with solvents. While solvent based materials have demonstrated the ability to meet standard performance requirements for curing, they are used preferentially in sealing applications.

The prior art provides for wax emulsion compositions, and a process for improving the early strength of cement aggregate products, in a stabilized aqueous emulsion with a surfactant such as alkali metal salts of fatty acids, alkali metal salts of sulfated fatty acids, alkali metal alkyl sulfates, alkali metal alkyl sufonates, alkali metal aryl sufonates, alkali metal alkyl lauryl sulfonate, alkali metal salts of alkylated naphthalene, alkali metal salts of lignosulfonic acid, condensation products of ethylene oxide and polyalkylene glycols, fatty acid glycerides, fatty acid amides, polyethylene sorbitol esters of fatty acids, quarternary ammonium halides, sorbitan esters, sulfonated or sulfated fatty acid esters or amides, and sulfonic acid.

The prior art also indicates wax emulsions have been identified as good film-forming materials, but lacking the overall water retention capability unless coupled with other resins or components, such as hydrocarbon resins.

Such wax emulsions based curing compositions are required to meet the ASTM C 309 Standard, which calls for certain rate of evaporation and reflectance values, both of which are related to the film structure developed upon application. Products in use today do not offer consistent film forming properties to meet the values of the ASTM C 309, especially in moisture retention and reflectance.

It is an object of this invention to provide wax emulsions with improved, uniform and predictable film formation, and increased bonding between the sealing composition and the concrete substrate, thereby increasing the moisture retention, reflectance and/or compressive strength of the cured.

### SUMMARY OF THE INVENTION

In one embodiment, the present invention provides an aqueous emulsion, useful as a curing compound for cementitious mixes, to achieve water loss levels of <0.55kg/m² in 72 hours, at a 150-200 ft²/gal (3.68-4.91 m²/l) application rate as tested in accordance with ASTM C 309, which emulsion includes a paraffin hydrocarbon wax and an alkanol ethoxylate or an alkylphenol ethoxylate surfactant.

In another embodiment, the present invention provides an aqueous emulsion, useful as a curing compound for cementitious mixes, to achieve water loss levels of <0.55kg/m² in 72 hours, at a 150-200 ft²/gal (3.68-4.91 m²/l) application rate as tested in accordance with ASTM C 309, which emulsion includes, in addition to water, essentially only a paraffin hydrocarbon wax and an alkanol ethoxylate or an alkylphenol ethoxylate surfactant.

In another embodiment, the present invention provides a method for preparing an aqueous emulsion, useful as a curing compound for cementitious mixes, to achieve water loss levels of <0.55kg/m² in 72 hours, at a 150-200 ft²/gal (3.68-4.91 m²/l) application rate as tested in accordance with ASTM C 309, which method includes the steps of combining water, a paraffin hydrocarbon wax and an alkanol ethoxylate or an alkylphenol ethoxylate surfactant, heating the combination to a temperature of between about 185° F. (85° C.) to about 205° F. (96.1° C.), then homogenizing the mixture.

In one embodiment, the present invention provides an aqueous emulsion, useful as a curing and sealing compound for cementitious mixes, to achieve water loss levels of <0.55kg/m² in 72 hours, at a 150-200 ft²/gal (3.68-4.91 m²/l) application rate as tested in accordance with ASTM C 309, which emulsion includes a paraffin hydrocarbon wax and an alkanol ethoxylate or an alkylphenol ethoxylate surfactant.

In another embodiment, the present invention provides an aqueous emulsion, useful as a curing compound for cementitious, to achieve water loss levels of <0.55kg/m² in 72 hours, at a 150-200 ft²/gal (3.68-4.91 m²/l) application rate, and a daylight reflectance of >60% as tested in accordance with ASTM C 309, which emulsion includes, in addition to water, essentially only a paraffin hydrocarbon wax and an alkanol ethoxylate or an alkylphenol ethoxylate surfactant.

In another embodiment, the present invention provides for concrete and cement formulations coated or sealed with the compositions described herein.

### DETAILED DESCRIPTION OF THE INVENTION

It has been found that the aqueous emulsion compositions of the invention, when applied to the surface of freshly poured or placed concrete, provide superior water retention properties, which reduce the loss of water during the early hardening period, and meets the standard requirements of tests such as ASTM C 309. The emulsion compositions include a paraffin hydrocarbon wax and an alkanol ethoxylate and/or an alkylphenol ethoxylate surfactant. It has been found that the aqueous emulsion compositions of the invention are highly compatible with pigments such as titanium dioxide, which when added to the emulsions, serve the purpose of reducing the temperature rise in concrete exposed to radiation from the sun.

Suitable paraffin hydrocarbon waxes include paraffin waxes, slack waxes and scale waxes. Such waxes are commercially known to be of low volatility, exhibiting less than about a 10% loss in weight during standard thermogravimetric analysis. Also, the oil content of these waxes is typically less than about 5% by weight, preferably less than about 1% by weight.

In one embodiment the wax is a paraffin wax having a melting point in the range of about 50° C. to about 70° C. In another embodiment the wax is a paraffin wax containing one or more CₙH₂ₙ₊₂ hydrocarbons, where n is an integer between 18 and 42. In another embodiment the paraffin wax is a predominantly straight chain hydrocarbon having an average chain length of 20 to 30 carbon atoms. In another embodiment, the waxes are of a relatively high molecular weight, having an average chain length of C₃₆, that is a 36 carbon chain length, or greater.

Paraffin waxes are typically derived from light lubricating oil distillates, and suitable paraffin waxes include Wax 3816 available from Honeywell/Astor of Duluth, Ga. Slack waxes are petroleum waxes having an oil content of 3 to 50 wt %. Suitable slack waxes include Exxon 600 Slack Wax and Ashland 200 Slack Wax, or a combination thereof.

The paraffin hydrocarbon wax may comprise about 10 to about 55 wt %, about 10 to about 35 wt % or about 10 to about 25 wt %, with the wt % being based on the entire weight of the emulsion.

Suitable alkanol ethoxylate surfactants include one or more of those of the formula R—O—(CH₂ —CH₂—O)ₓ—H, where R is a linear or branched alkyl group containing 8-18 carbon atoms and x indicates the average number of ethylene oxide is an integer of 1 or more, from 1 to 9 or from 3 to 9.

Suitable alkylphenol ethoxylate surfactants include one or more of those of the formula R—Ar—(OCH₂CH₂)ₓ—OH, where R is a linear or branched alkyl group containing 8-18, 8-12 or 8-9 carbon atoms, Ar is an aromatic group, x indicates the average number of ethylene oxide units in the ether side chains and may be 1 or more, 4 or more, from 4 to 30, from 7 to 15, from 8-12 or from 8-9. In one embodiment the alkylphenol ethoxylate includes octylphenol ethoxylate, nonylphenyl ethoxylate or combinations thereof.

In one embodiment, the surfactant may comprise about 0.015 to about 5 wt % or about 0.25 to about 5 wt %, with the wt % being based on the entire weight of the emulsion. In another embodiment the surfactant includes combinations of alkanol ethoxylates, combinations of alkylphenol ethoxylates, or combinations of one or more alkanol ethoxylates with one or more alkylphenol ethoxylates.

The aqueous emulsions of the invention may optionally include a finely-divided white pigment, such as TiO₂. When utilized, the finely divided white pigment is present in an amount of about 1 to about 10 wt %, with the wt % being based on the entire weight of the emulsion.

The aqueous emulsions of the invention may optionally include a linear C₁₂ to C₂₂ fatty acid. Suitable fatty acids include, but are not limited to, lauric acid, palmitic acid, stearic acid, behenic acid, oleic acid, linoleic acid, linolenic acid and mixtures thereof. For the purposes of this application, the term “linear” as used describe the fatty acids means the carbon chains of the fatty acid are substantially linear, having less than 5 percent of the non alpha carbons in the carbon chains being substituted with a methyl or higher alkyl group. The acids may be saturated, unsaturated or polyunsaturated. When utilized, the fatty acid is present in an amount of about 0.5 to 3.5 wt % based on the entire weight of the emulsion.

The aqueous emulsions may optionally include a compound having an amine group. In one embodiment the amine is an alkanolamine. Alkanolamines that may be useful with the invention include, but are not limited to, a basic amine of the desired reactivity such as diethanolamine (DEA), triethanolamine (TEA), or 2-amino-2-methyl-1-propanol. When utilized, the compound having an amine group is present in an amount of about 0.5 to about 5 wt % based on the entire weight of the emulsion.

The aqueous emulsions of the invention may also optionally include an effective amount of a defoamer, such as for example any commercially available silicone defoamer.

In one embodiment, the aqueous emulsion compositions of the invention are used as a curing or sealing compound, and also components of the emulsion are incorporated or admixed in the preparation of the cement mixes, for example as part of the aqueous component, which is believed to provide additional compatibility leading to both desired strength requirements and desired water retention properties. Such cement mixes may be free of high range water reducers, viscosity or rheology modifiers, or mix retarders.

In one embodiment, the aqueous emulsion of the invention is applied as a surface coating, and is not utilized as an aqueous ingredient in the preparation of a cementitious product.

In one embodiment, the aqueous emulsion of the invention is advantageously utilized to achieve water loss levels of <0.55kg/m² in 72 hours, at a 150-200 ft²/gal (3.68-4.91 m²/l) application rate as tested in accordance with ASTM C 309.

In one embodiment, the aqueous emulsion of the invention is advantageously utilized to achieve a daylight reflectance of >60% at a 150-200 ft²/gal (3.68-4.91 m²/l) application rate as tested in accordance with ASTM C 309.

In one embodiment, the aqueous emulsions of the invention are free of coagulants which coagulate film forming synthetic polymers when those polymers are in the presence of calcium ions of fresh concrete or mortar. In another embodiment, the emulsions of the invention are free of synthetic polymers.

In one embodiment, the aqueous emulsions of the invention are free of olefin-maleic anhydride derivatives.

In one embodiment, the aqueous wax emulsions are prepared in a homogenizer. With homogenization it is preferred that a distribution of micelle diameters ranging from about 0.6 micron to about 1.8 micron be achieved. However, the distribution of micelle diameters may range from about 0.5 micron to about 2.5 micron. This level of homogenization may be attained, for example, by using a dual orifice homogenizer operating at from about 2,000 to about 4,000 psig.

### EXAMPLES

Table 1 sets forth the formulations utilized in the examples 1 to 10 and the results for ASTM C 309 water retention and the daylight reflectance tests. TiO2 was added in compositions 2, 5 and 7 to achieve the ASTM C 309 Type 2 membrane-forming compound.

In a typical preparation, the water and any water soluble components were combined then heated to a temperature of between about 185° F. (85° C.) to about 205° F. (96.1° C.). The wax composition was incorporated and also heated to a temperature of between about 185° F. (85° C.) to about 205° F. (96.1° C.). The resultant mixture was then placed in a homogenizer. TiO2 was added in compositions 2, 5 and 7 to achieve the ASTM C 309 Type 2 membrane-forming compound.

TABLE 1
Composition Formulations/ASTM C 309 Results

| | | | | | | Water | Daylight |
|---|---|---|---|---|---|---|---|
| | | | | | | Retention | Relectance |
| | Cascowax ™ | Cascowax ™ | Tergitol ™ | | | ASTM C | ASTM C |
| | EW 58LV | EW 58A | NP9 | TiO₂ | Water | 309 | 309 |
| Ex. | wt % | wt % | wt % | wt % | wt % | Kg/m² | % |
| 1 | 30 | 0 | 0.50 | 0 | 69.50 | 0.38 | 51 |
| 2 | 30 | 0 | 0.50 | 9 | 60.50 | 0.24 | 81 |
| 3 | 30 | 0 | 0.25 | 0 | 69.75 | 0.11 | 63 |
| 4 | 30 | 0 | 0.10 | 0 | 69.90 | 0.34 | 58 |
| 5 | 30 | 0 | 0.50 | 2 | 67.50 | 0.36 | 66 |
| 6 | 30 | 0 | 0.95 | 0 | 69.05 | 0.19 | 55 |
| 7 | 30 | 0 | 0.25 | 2 | 67.75 | 0.31 | 66 |
| 8 | 20 | 0 | 0.25 | 0 | 79.75 | 0.54 | 63 |
| 9 | 0 | 30 | 0.25 | 0 | 69.75 | 0.41 | 63 |
| 10 | 0 | 20 | 0.25 | 0 | 79.75 | 0.44 | 64 |

Cascowax™ EW 58LV is an aqueous emulsion containing approximately 54 w% weight of an LV slack wax and Cascowax™ EW 58A is an aqueous emulsion containing approximately 54 wt % of a paraffin wax. Both are commercially available from Momentive Specialty Chemicals Inc. Tergitol™ NP-9 is a nonylphenyl ethoxylate containing 9 ethylene oxide units in the ether side chain, and is commercially available from The Dow Chemical Company.

While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the present invention.

1. An aqueous curing or sealing emulsion comprising:
a paraffin hydrocarbon wax; and
a surfactant comprising an alkanol ethoxylate or an alkylphenol ethoxylate;
wherein the aqueous curing or sealing emulsion is applied to or admixed with a cementitious composition; and
wherein the cementitious composition achieves a water loss level of <0.55kg/m2 in 72 hours, at a 150-200 ft2/gal (3.68-4.91 m2/l) application rate as tested in accordance with ASTM C 309.

2. The aqueous curing or sealing emulsion of claim 1 wherein the paraffin hydrocarbon wax comprises one or more of a paraffin wax, a slack wax or a scale wax.

3. The aqueous curing or sealing emulsion of claim 2 wherein the paraffin hydrocarbon wax is a paraffin wax containing one or more CₙH₂ₙ₊₂ hydrocarbons, where n is an integer between 18 and 42.

4. The aqueous curing or sealing emulsion of claim 1 wherein the surfactant comprises one or more alkanol ethoxylate surfactants of the formula R—O—(CH2—CH2—O)x-H, where R is a linear or branched alkyl group containing 8-18 carbon atoms and x an integer of 1 to 9.

5. The aqueous curing or sealing emulsion of claim 1 wherein the surfactant comprises one or more alkylphenol ethoxylate surfactants of the formula R—Ar—(OCH2CH2)x-OH, where R is a linear or branched alkyl group containing 8-18 carbon atoms, Ar is an aromatic group, x is from 4 to 30.

6. The aqueous curing or sealing emulsion of claim 5 wherein the one or more alkylphenol ethoxylate surfactants is octylphenol ethoxylate, nonyiphenyl ethoxylate or a combination thereof.

7. The aqueous curing or sealing emulsion of claim 1 comprising about 10 to about 55 wt % paraffin hydrocarbon wax; and
about 0.015 to about 5 wt % surfactant;
wherein the wt % is based on the entire weight of the emulsion.

8. The aqueous curing or sealing emulsion of claim 1 further comprising about 1 to about 10 wt % TiO₂, wherein the wt % is based on the entire weight of the emulsion.

9. The aqueous curing or sealing emulsion of claim 8 wherein the cementitious composition achieves a daylight reflectance of >60% at a 150-200 ft2/gal (3.68-4.91 m2/l) application rate as tested in accordance with ASTM C 309.

9. The aqueous curing or sealing emulsion of claim 1 further comprising about 0.5 to about 3.5 wt % of a C₁₂ to C₂₂ fatty acid, wherein the wt % is based on the entire weight of the emulsion.

10. The aqueous curing or sealing emulsion of claim 1 wherein the emulsion is free of synthetic polymers.

11. The aqueous curing or sealing emulsion of claim 1 wherein the emulsion is free of olefin-maleic anhydride derivatives.

12. A method of preparing an aqueous curing or sealing emulsion comprising:
forming a combination of water, a paraffin hydrocarbon wax, and an alkanol ethoxylate or an alkylphenol ethoxylate surfactant;
heating the combination to a temperature of about 185° F. (85° C.) to about 205° F. (96.1° C.);
homogenizing the combination; and
applying or admixing the combination on or in a cementitious composition;
wherein the cementitious compositions achieves a water loss level of <0.55kg/m2 in 72 hours, at a 150-200 ft2/gal (3.68-4.91 m2/l) application rate as tested in accordance with ASTM C 309.
